(19) United States
(12) Patent Application Publication
(10) Pub. No.: US 2025/0225659 A1
(43) Pub. Date: Jul. 10, 2025

(54) METHOD AND APPARATUS WITH MACHINE LEARNING BASED IMAGE PROCESSING

(71) Applicant: Samsung Electronics Co., Ltd., Suwon-si (KR)

(72) Inventors: Myungsub CHOI, Suwon-si (KR); Sangwon LEE, Suwon-si (KR); Nagyeong LEE, Suwon-si (KR); Hyong Euk LEE, Suwon-si (KR)

(73) Assignee: Samsung Electronics Co., Ltd., Suwon-si (KR)

(21) Appl. No.: 19/005,621

(22) Filed: Dec. 30, 2024

(30) Foreign Application Priority Data
Jan. 4, 2024 (KR) 10-2024-0001583

(51) Int. Cl. G06T 7/10; G06N 3/0475

(52) U.S. Cl. CPC G06T 7/10; G06N 3/0475; G06T 2207/20084

(57) ABSTRACT

A method and apparatus will machine learning-based image processing is provided. The method includes generating a plurality of output images using a generative model that is provided a raw image of an image sensor, generating, using a machine vision model that is provided the plurality of output images, plural output data respectively corresponding to the plurality of output images, generating result data of the machine vision model by performing an ensemble on the plural output data.

### CROSS-REFERENCE TO RELATED APPLICATIONS

This application claims the benefit under 35 USC § 119(a) of Korean Patent Application No. 10-2024-0001583, filed on Jan. 4, 2024, in the Korean Intellectual Property Office, the entire disclosure of which is incorporated herein by reference for all purposes.

### BACKGROUND

### 1. Field

The following description relates to a method and apparatus with machine learning-based image processing.

### 2. Description of Related Art

As non-limiting examples, portable electronic devices may include mobile phones, tablets, digital cameras, or camcorders, notebook computers, etc., which may capture images.

For example, electronic devices may include image sensors that capture images and may store the captured images in a storage (e.g., at the same time as when the image is captured). Such stored images may be reproduced by the corresponding electronic device or other electronic devices at any time, for example. Such electronic devices may provide high performance and multifunctionality in addition to compactness, lightening, and low power consumption, as non-limiting examples.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor-implemented method includes generating a plurality of output images using a generative model that is provided a raw image of an image sensor, generating, using a machine vision model that is provided the plurality of output images, plural output data respectively corresponding to the plurality of output images, generating result data of the machine vision model by performing an ensemble on the plural output data.

The generating of the plurality of output images may include generating a plurality of noise images through random sampling, and generating the plurality of output images by the generative model respectively based on the generated plurality of noise images.

The generating of the plurality of noise images may include generating the plurality of noise images based on respective performances of at least one of Gaussian sampling or Poisson sampling.

Each of the plurality of output images may be differently generated by inputting the raw image and a respective different noise image into the generative model.

The ensembling of the plural output data may include performing a combining of respective probabilistic data of the plural output data, or selecting of respective probabilistic data from among the plural output data, to generate the result data.

The ensembling of the plural output data may include performing the selecting, which may include generating the result data using a determined maximum confidence value for each corresponding element of the probabilistic data of the plural output data, where each of the plural output data may include plural probabilistic data elements.

The generative model may include at least one of a diffusion model or a generative adversarial network (GAN) model.

The plurality of output images may be red, green, and blue (RGB) images that may be respectively generated by the generative model corresponding to the raw image that is input to the generative model.

The machine vision model may include at least one of an object detection model, an image segmentation model, or defect detection model.

The generative model may be trained to optimize a performance of the machine vision model.

The generative model and the machine vision model may be trained together end-to-end.

The method may further include training the generative model and the machine vision model together end-to-end.

The plurality of output images may include different semantic information.

The generating of the plurality of output images may be performed using one or more pipelines of processing elements of a generative image signal processor (ISP).

In one general aspect, an electronic device includes an image sensor configured to generate a raw image and a processor configured to generate a plurality of output images using a generative model provided the raw image, generate, using a machine vision model that is provided the plurality of output images, plural output data respectively corresponding to the plurality of output images, and generate result data of the machine vision model through performance of an ensemble on the plural output data.

The processor may be further configured to generate a plurality of noise images through random sampling, and may be configured to generate each of the plurality of output images by the generative model based on a corresponding one of the generated plurality of noise images input to the generative model.

For the ensembling, the processor may be configured to perform a combining of respective probabilistic data of the plural output data, or a selecting of respective probabilistic data from among the plural output data, to generate the result data.

For the ensembling, the processor may be configured to perform the selecting, which may include a generation of the determined result data using a determined maximum confidence value for each corresponding element of the probabilistic data of the plural output data, where each of the plural output data may include plural probabilistic data elements.

The plurality of output images may be red, green, and blue (RGB) images that may respectively be generated by the generative model corresponding to the raw image that is input to the generative model.

The processor may include at least a generative image signal processor (ISP) that is configured to implement the generative model using one or more pipelines of processing elements of the generative ISP.

The generative model and the machine vision model may be configured as having been trained together end-to-end.

Other features and aspects will be apparent from the following detailed description, the drawings, and the claims.

### BRIEF DESCRIPTION OF THE DRAWINGS

FIG. 1 illustrates an example system in accordance with one or more embodiments.

FIGS. 2A and 2B respectively illustrate example discriminative and generative models in accordance with one or more embodiments.

FIG. 3 illustrates an example system with image processing in accordance with one or more embodiments.

FIG. 4A illustrates an example training method of a generative model in accordance with one or more embodiments.

FIG. 4B illustrates an example method with image processing in accordance with one or more embodiments.

FIG. 5 illustrates example generated images in accordance with one or more embodiments.

FIG. 6 illustrates an example electronic device in accordance with one or more embodiments.

Throughout the drawings and the detailed description, unless otherwise described or provided, the same drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment”, and “one or more examples” has a same meaning as “in one or more embodiments”).

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and specifically in the context on an understanding of the disclosure of the present application. Terms, such as those defined in commonly used dictionaries, are to be interpreted as having a meaning that is consistent with their meaning in the context of the relevant art and specifically in the context of the disclosure of the present application, and are not to be interpreted in an idealized or overly formal sense unless expressly so defined herein.

Example electronic devices and systems herein may include various types of products such as a personal computer, a laptop computer, a tablet computer, a smart phone, a television, a smart home appliance, an intelligent vehicle, a kiosk, and a wearable device, as non-limiting examples.

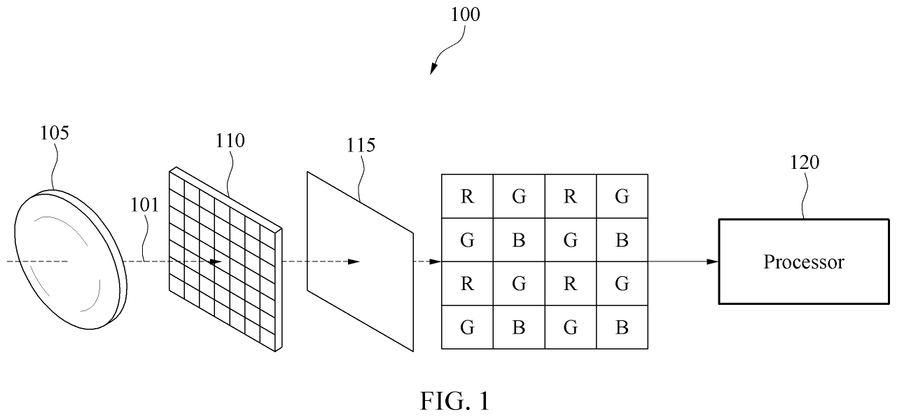

FIG. 1 illustrates an example electronic device or system in accordance with one or more embodiments.

Referring to FIG. 1, an electronic device or system 100 may be, or include, a mobile device, such as a smartphone, a tablet personal computer (PC), a camera, or other devices, including non-mobile devices. The electronic device or system 100 may include a lens 105, a color filter array (CFA) 110, an image sensor 115, and a processor 120. However, not all the shown components are provided in all embodiments. In addition, the electronic device or system 100 may include more or less components than the illustrated components. In an example, the electronic device or system 100 may further include a controller, memory, and a display.

At least one of the components of the electronic device or system 100 (e.g., at least one of the CFA 110, the image sensor 115, and/or the processor 120) may be hardware elements of a single integrated system, such as a system-on-chip (SoC) or other integrated systems. In various examples, the CFA 110 and the image sensor 115 may be integrated, such as when pixels of the CFA 110 are formed or arranged on a surface of the image sensor 115. In various examples, the lens 105, CFA 110, and image sensor 115 may be an integrated hardware, such as a camera module.

Light 101 may pass through the lens 105 and fall incident on the CFA 110, and upon passing through the CFA 110 may be sensed by the image sensor 115. The image sensor 115 may generate image (e.g., a CFA image) using the received light. The lens 105 may include any suitable lens(es), and nonlimiting examples may include rectilinear lens(es), wide-field (or “fisheye”) lens(es), fixed focal length lens(es), zoom lens(es), fixed aperture lens(es), and/or variable aperture lens(es). As non-limiting examples, the image sensor 115 may include a complementary metal-oxide semiconductor (CMOS) image sensor, a charge-coupled device (CCD) image sensor, or other suitable image sensors.

Thus, the image sensor 115 may convert light into an electrical signal using a light-receiving element, and in this case, the received light may be indicated as specified intensities of visible light, for example, of a specific wavelength range(s). Through use of the CFA 110, for example, the intensities of different colors may also be respectively provided. For example, recognizable color conversion may be possible by identifying the intensity of light of a wavelength at a position on the image sensor and corresponding position on the CFA.

Herein, the signal sampled by image sensor, based on light incident to the CFA, 110 may be referred to as any of a raw image, raw data, a CFA input image, a CFA pattern, and a raw image of a CFA pattern, for example. An image obtained by imaging processing a raw image with an image signal may be referred to as an RGB image or an output image. For example, the processor 120 may include or be a generative image signal processor (ISP) that may generate an image, e.g., an RGB image, from the raw image or otherwise raw intensity data sensed by the image sensor.

Typical ISPs may be implemented as a pipeline of multiple processor operations implemented in respective hardware processors (also referred to as processor elements) or though software by one or more processors (e.g., by a total number of such processors equal to, less than, or more than a total of the number of processor operations). For example, a typical ISP may perform various sequential processor operations, such as demosaicing, denoising, auto white balance (AWB), and tone mapping (e.g., respectively performed by different processor elements in a pipeline). Such typical ISP pipelines may have different configurations and tuning parameters depending on each manufacturer and which particular image processing operations are performed.

These typical ISPs are used in products that have or depend on cameras, including products that perform autonomous vehicle/pedestrian recognition, semiconductor inspection, and machine vision, as non-limiting examples. However, since typical ISPs have been developed mainly in the form of simulating or adapting to the human visual system, tuning parameters of the various image processor operations for raw images are generally set to be easy or pleasing for human eyes, and for human perception. However, how humans perceive images or the limits on human perception, as well as image processing for ease in view by a human, are not limitations of machine viewing systems, and thus, optimization settings of the image processing operations in the typical ISP pipeline may not be relevant or as important as settings of the same, or other different image processing operations, for optimizing a performance of a machine vision system. Therefore, as a non-limiting example of a reason for the same, the present inventors have found that for a more effective machine vision system, it may be beneficial for the configuration, operations, and parameters of a generative ISP pipeline for machines, e.g., for machine vision or other application purposes, to be different than typical ISP pipelines.

Thus, the processor 120 may be or include a generative ISP, e.g., for machine vision, according to various embodiments. The generative ISP may include one or more generative models, e.g., machine learning or other artificial intelligence (AI) generative models. A generative model is trained or learns an underlying distribution of data, and may be stronger in terms of variances in input and environment compared to existing discriminative models (e.g., models that may discriminate between classes of information to generate an output). In various embodiments, the generative ISP may be used in various image acquisition devices (e.g., cameras, medical imaging devices, semiconductor measurement equipment, autonomous vehicle cameras, etc., also as various embodiments) for machine vision purposes, or based thereon, and may still operate as intended even if there are changes in the lens/sensors that capture the raw image information. In various examples, machine vision application examples, such as object detection/recognition in a mobile camera embodiment, using the generative ISP may have an improved performance over previous machine vision applications using a typical ISP, and/or may provide an improved and/or more specialized configuration of one or more pipelines of processing elements (or respective image processing operations) in an image acquisition device or other device that may have at least one purpose of solving a machine vision issue, as a non-limiting example, such as in a camera for an autonomous vehicle (e.g., where the camera may include the image sensor and such a generative ISP according to examples).

Embodiments include various electronic devices that use, or generate and use, raw image data. Raw image data includes data that is generated by an image sensor (e.g., image sensor 115 of FIG. 1) to represent the intensity of incident light, such as by the conversion of light incident on the image sensor into electrical signals. An image sensor may itself include one or more such light conversion sensors. The generated electrical signals may be stored in the form of the raw image data. In a non-limiting example where light is first incident on an example CFA (e.g., CFA 110 of FIG. 1) before being incident on the image sensor, the raw image data may be considered a CFA raw image, such as illustrated in FIG. 1. For example, such CFA raw image data may typically be generated and stored (e.g., temporarily stored) in the form of a Bayer CFA (e.g., in accordance with the Bayer arrangement of the different wavelength filters in the CFA. A generative ISP (e.g., processor 120 of FIG. 1) according to various embodiments may convert the CFA raw image data into a 3-channel standard RGB (SRGB) image through image signal processing by the generative ISP. The image signal processing may include various image processing processes such as demosaicing, denoising, and tone mapping.

Most typical ISPs may perform such demosaicing, denoising, and tone mapping in conformance with the configuration of the typical ISPs (e.g., based on various particular input parameter values and corresponding hardware configurations) that are tuned to generate images that are visually easy or pleasing to human eyes and based on human visual perspective standards. Thus, these typical ISPs are designed for human vision and are effective for capturing pictures and images with mobile cameras for human consumption, but may not be suitable for solving machine vision issues, such as issues that arise with respect to autonomous vehicles that may need to recognize surrounding environments or with respect to defect detection equipment that may need to detect product errors or anomalies on a factory production line.

A generative ISP according to various embodiments may be a generative ISP for machine vision including processing elements configured in a manner that provide image processed images that when provided to a machine learning models, and/or used to train such machine learning models, provides improved performance over machine learning models that may be provided images generated by a typical ISP, and/or that may be trained using such typical ISP generated images. Thus, a generative ISP according to various embodiments may improve the performance of machine vision operations.

For example, typical machine vision systems perform various tasks, such as object recognition and error detection, with sRGB images generated by typical ISPs. However, since configurations and/or parameter values of such typical ISPs are not tuned for machine vision purposes, and may be configured with mechanisms for internal operations for corporate or other human visual product purposes, which are typically difficult to precisely understand as they may be corporate secrets, it may be difficult to automatically adjusts the configuration or tuning of the parameters of typical ISPs for non-human interest tasks, such as for machine vision proposes.

In addition, even when the parameters of typical ISPs have been automatically tuned for generating images from raw image data for use by machine vision models, or otherwise used for machine learning issues, there are limits that only limited ISP structures may be available in the typical ISPs or only an order of configuration of existing processing elements (e.g., in a pipeline) of a given ISP may be changed. Since most existing ISP structures of typical ISPs include processing elements configured for performing image processing operations for human vision, it is difficult to obtain optimal performance in machine vision application issues using the existing ISP structures.

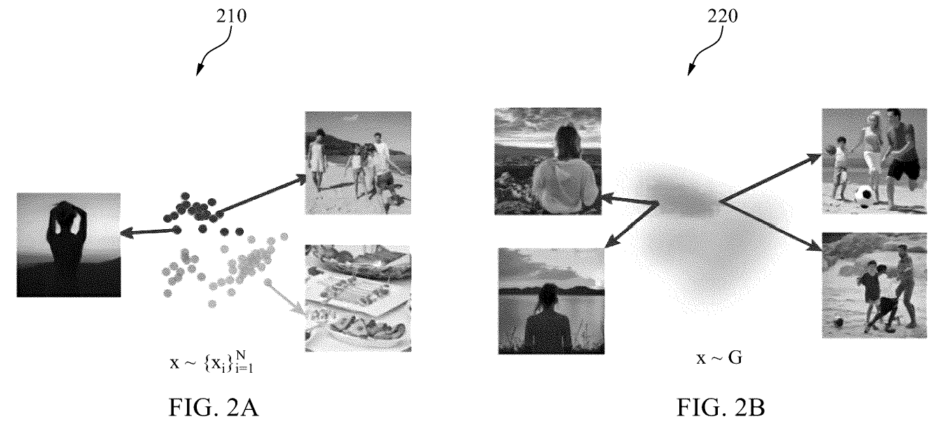

FIGS. 2A and 2B respectively illustrate example discriminative and generative models in accordance with one or more embodiments.

Unlike a discriminative model 210 in FIG. 2A that may be trained to perform the image processing operations of a typical ISP through fixed image processing mappings, a generative model 220 in FIG. 2B operates based on a trained underlying distribution of data, and thus, there are advantages of easier processing on outliers and better generalization performance with the generative model 220.

The discriminative model 210 typically discriminates between information, such as by classifying input information based on trained classes of information. For example, parameters (e.g., weights) of the discriminative model 210 may be trained through optimizations toward the generation of an output with the lowest error in a given dataset, such as through supervised training toward lowering the error between a correct or ground truth result and the output result of the discriminative model 210 during training. As a non-limiting example, if the discriminative model 210 is used to perform an image processing operation on a raw image data, for example, then the correct or ground truth result may be a predetermined accurate processed image (e.g., for the raw image data) and the discriminative model 210 would be trained until the output of the discriminative model 210 modifies the input raw image to sufficiently match the predetermined accurate processed image. Thus, the discriminative model 210 is trained based on a dataset of output images, e.g., to output a particular image for a particular input image. For example, for an input raw image (e.g., mapped to one of the data points in FIG. 2A) the discriminative model 210 would output a particular image (e.g., a corresponding illustrated image in FIG. 2A). Said another way, output images may be embedded into an image space during the training of the parameters of the discriminative model 210 such that when a raw image is input to the discriminative model 210 the corresponding/mapped processed image in that embedded image space will be output by the discriminative model 210. As a raw image is the only input to the discriminative model 210, the discriminative model 210 may be implemented by a typical ISP with modifications to the operations of the processing elements of the typical ISP to perform the respective operations of the trained discriminative model 210 (e.g., based on the trained parameters of the discriminative model 210).

Differently, the generative model 220 may be trained to understand the distribution of given dataset(s) to represent that distribution understanding in the trained parameters of the generative model 220. The generative model 220 may be trained to predict a correct result or answer through a sampling from the distribution of the given dataset, rather than relying on a particular one to one mapping of a datapoint in an image space to a particular output image that may be performed by the discriminative model 210. Therefore, a generative ISP, i.e., an ISP based on one or more generative models, may be stronger to various environments that may be encountered in actual machine vision issues, and may show excellent performance, compared to a typical ISP and compared to an ISP based on a discriminative model.

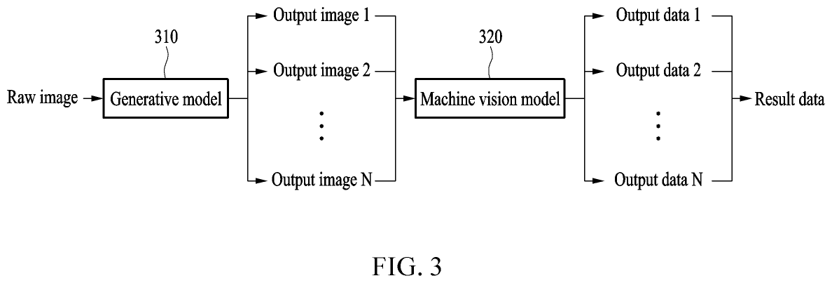

FIG. 3 illustrates an example system with image processing in accordance with one or more embodiments. The description provided with reference to FIGS. 1 to 2B may also apply to FIG. 3.

Referring to FIG. 3, a system with image processing may include a generative model 310 and a machine vision model 320 as main agents.

The generative model 310 may receive a raw image and may generate a plurality of output images. In an example, the generative model 310 may be implemented by a generative ISP. Thus, the generative model 310 may be a model trained to perform image signal processing for machine vision. The generative model 310 may also be representative of one or more generative models. The generative model 310 may be provided the raw image and may generate a plurality of RGB images, such as through respective operations of the generative model 310 with different seeds and/sampling method settings, as non-limiting examples. An RGB image generated by the generative model 310 may be an image suitable for performing machine vision tasks.

As described in detail below, the generative model 310 may perform image signal processing including random sampling. Therefore, the generative model 310 may generate different output images (e.g., slightly different output images) depending on a random seed and sampling method, even with the same input raw image.

The generative model 310 may be any one or include any combination of various types of generative models such as a generative adversarial network (GAN), a variational autoencoder (VAE), and/or a diffusion model. Such generative models include differentiable operations, so the generative model 310 may be optimized to maximize a final performance of a desired machine vision system through a gradient-based first order optimizer, etc., or other training techniques. For example, while the generative model 310 may itself be trained to performed desired image processing operations, the generative model 310 and any subsequent machine learning or AI model(s) (e.g., the machine vision model 320) may be trained together (e.g., end-to-end) for an optimized performance of the result of the subsequent machine learning or AI model(s).

The machine vision model 320 may receive a plurality of output images generated by the generative model 310 and may generate pieces of output data respectively corresponding to the plurality of output images. For example, the generative model 310 may be implemented simultaneously multiple times to respectively generate the plurality of output images, such as through separate corresponding pipelines of the generative ISP or through at least plural pipelines until all of the plurality of output images are generated. Furthermore, the machine vision model 320 may determine result data by performing an ensemble on the pieces of output data.

In an example, the machine vision model 320 may use, as input, output images of the generative model 310 with randomness. The machine vision model 320 may be a model trained to perform machine vision tasks and may include an object detection model, an image segmentation model, or a defect (e.g., error or anomaly) detection model, as non-limiting examples.

In an example, the final output (result data) of the machine vision model 320 may be generated by ensembling the output data of each sample (output images). For example, the machine vision model 320 may determine result data (e.g., probabilistic data) based on statistical values (e.g., an average) of corresponding probabilistic data elements from each of the pieces of output data. Alternatively, the machine vision model 320 may determine output data with the respective maximum probability values (confidences) among the corresponding probabilistic data elements from each of the pieces of output data as result data. As a non-limiting example, each piece of output data may be a respective output map (e.g., a 2-dimensional array or map) having elements with respective probabilistic values, such that for each element of one of the output maps there may be a corresponding element of another one of the output maps. As an example, the result data may be a single output map (e.g., of a corresponding 2-dimensional array or map) derived from two or more of the plural output maps.

The advantage of the method of determining result data through an ensemble may be that an unexpected result value for specific noise or data distortion may be prevented as input data of a machine vision system becomes diverse, thereby improving robustness of the system.

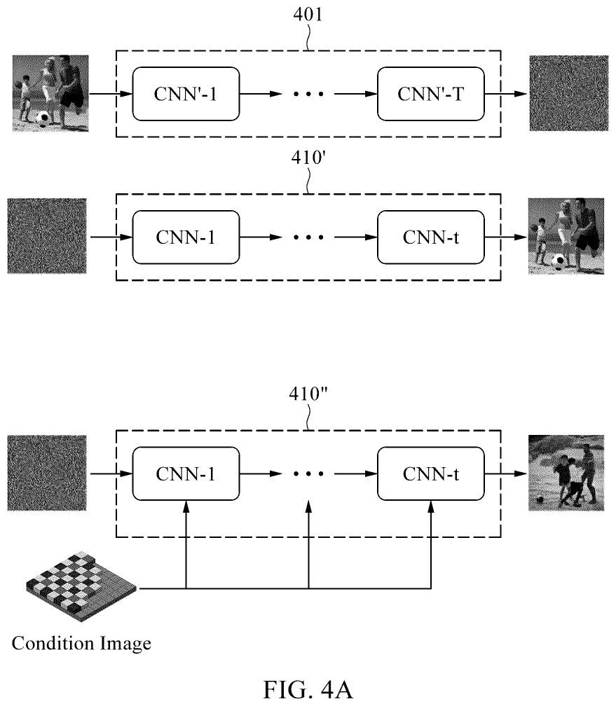

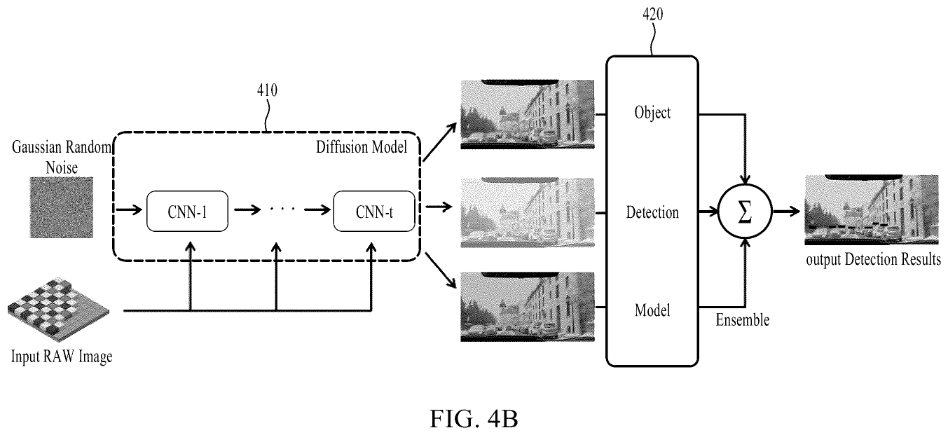

FIG. 4A illustrates an example training method of a generative model with one or more embodiments.

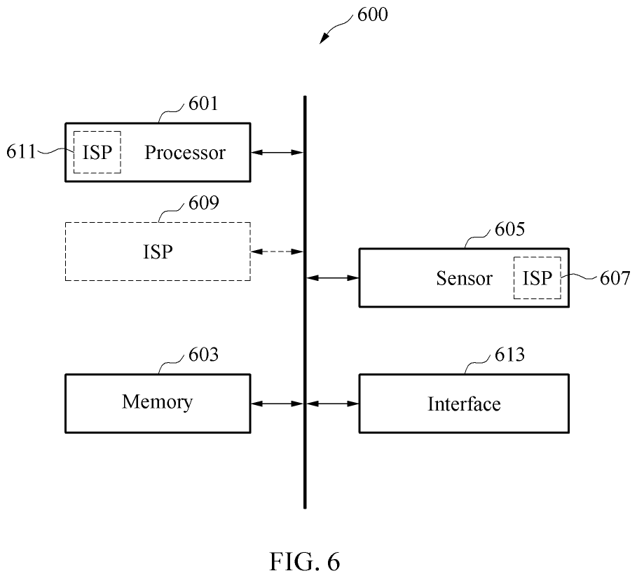

Referring to FIG. 4A, as a non-limiting example, a training input to a diffusion model 401 may be an RGB image (e.g., an RGB image set or optimized for use in machine learning operations), as a non-limiting example, and the diffusion model 401 may generate an output noise image (e.g., representing random or Gaussian noise). In an example, the RGB image may also represent an image that does not need image processing of a typical ISP, such as with the RGB image not suffering from mosaicing, white balance, tone mapping, or noise influences of an image sensor capturing (and/or image capturing environment) of the corresponding image information, noting that examples are not limited thereto. For example, the RGB image may be a result of a typical ISP. The output noise image may represent random or Gaussian noise. While the diffusion model 401 may be used in the training of generative model 410′, examples are not limited thereto. For example, other types of generative models, such as a GAN and VAE, may also be trained to generate the generative model that may be implemented by one or more processors (e.g., the processor 601 of FIG. 6) and/or by one or more generative ISPs (e.g., any or any combination of the generative ISPs 607, 609, and 611 of FIG. 6) according to various examples.

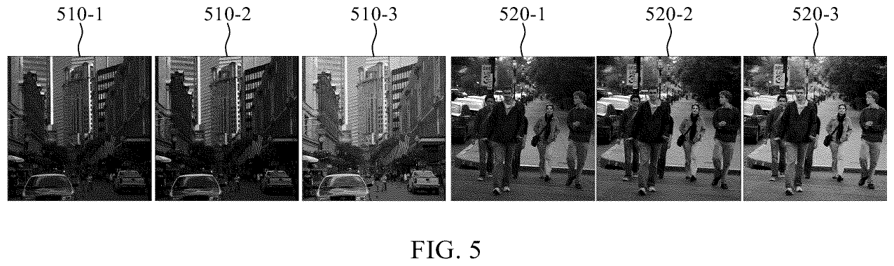

The diffusion model 401 may be trained to generate the noise image by applying or adding noise (e.g., Gaussian noise) to the RGB image little by little over T steps (e.g., through respective convolutional neural network (CNN) layers/blocks CNN′-1 . . . CNN′-T) to generate the output noise image. The generative model 410′ may be another diffusion model that is input the output noise image (output by the diffusion model 401) and trained to restore the output noise image to the RGB image (or restore to image information, such as predicted noise, that can be considered with the input output noise to generate the RGB image) through a process of removing noise from the output noise image through t steps (e.g., through respective CNN layers/blocks CNN-1 . . . CNN-t) of the generative model 410′. For illustrative purposes, the generated RGB image resulting from the implementation of the generative model 410′ is shown as being a same RGB image resulting from the generative model and corresponding distribution of FIG. 2B, and thus, the RGB image input to the diffusion model 410 to generate the output noise image that is input to the generative model 410′ is illustrated as being the same as generated RGB image. The number t steps of the restoring process of the generative model 410′ may match a linear schedule of the T steps of the noise adding process of the diffusion model 401, or may be a number of steps different from the noise adding process of the diffusion model 401 (e.g., according to a cosine schedule or a mixed linear and cosine schedule, with less overall steps t than the T steps). A generative model 410″ may be trained same as the generative model 410′ and further based on a condition, i.e., a condition in addition to the noise image input to the generative model 410″. For example, as discussed further below with respect to FIGS. 4B and 5, the generative model 410″ may be trained to generate an output RGB image (or image information that can be used to generate the output RGB) based on an input noise image with a condition of another image (e.g., a raw image captured by an image sensor) according to various embodiments. For illustrative purposes, and again based on the distribution of FIG. 2B, the RGB image generated by the generative model 410″ in FIG. 4A corresponds to another of the RGB images of FIG. 2B generated from the distribution of FIG. 2B. The generative models 410′ and 410″ may be trained through deep learning methodologies, such as through backpropagation based on calculated losses.

FIG. 4B illustrates an example method with image processing in accordance with one or more embodiments. The description provided with reference to FIGS. 1 to 4A may also apply to FIG. 4B.

Referring to FIG. 4B, an input of a generative model 410 (e.g., the trained diffusion model 410″ of FIG. 4A) may be noise and an image sensor raw image (e.g., as a condition) and an output may be respective RGB images having been processed differently through the generative model 410 according to different random noise. In an example, the input to the generative model 410 may be the raw image and the generative model 410 may be configured to generate the noise. Referring to FIG. 4B, the generative model 410 is shown as being a diffusion model, but examples are not limited thereto. For example, other types of generative models, such as a GAN and VAE, may also be used as the generative model 410. In addition, while the generative model 410 is represented as a single generative model, the generative model 410 may include multiple generative models. While the generative model 410 is explained as being a neural network, examples are not limited thereto.

Thus, the generative model 410 may generate an output image based on a noise image and a raw image (e.g., as captured by the image sensor of FIG. 1 or 6), as respective inputs to the generative model 410, by propagating the noise image and the raw image through a convolutional neural network over t steps (e.g., through CNN-1 to CNN-t convolutional layers/blocks, where each of CNN-1 to CNN-t may include at least one convolutional layer. While FIG. 4B illustrates that the output images are generated through such a convolutional neural network, examples are not limited thereto. Examples include any neural network being used instead of a convolutional neural network.

The generative model 410 may be provided and/or generate a plurality of noise images through random sampling, as a non-limiting example. As non-limiting examples, a noise generation model or corresponding portion of the generative model 410 may generate noise images based on respective Gaussian samplings and/or Poisson samplings.

The generative model 410 may generate multiple output images from a single input raw image based on different noise images (e.g., based on different random samplings). For example, the generative model 410 may obtain a first output image, based on the raw image and a first noise image obtained through random sampling. The generative model 410 may obtain a second output image based on the raw image and a second noise image obtained through another random sampling that results in a second noise image different from the first noise image. The generative model 410 may obtain a third output image based on the raw image and a third noise image obtained through still another random sampling that results in a third noise image different from both of the first and noise images. Although the generative model 410 generates all of the multiple output images based on the same raw image, since random sampling is used, the first output image, the second output image, and the third output image generated by the generative model 410 may be different. In an example, the generative model 410 may be implemented in parallel for each different noise image to generate each of the output images.

A machine vision model 420 may be an object detection model for performing a task of detecting an object instance in an image, but examples are not limited thereto. For example, the machine vision model may be a model for various vision tasks, such as an image segmentation model, image recognition, and a defect (e.g., error or anomaly) detection model, also as non-limiting examples.

The machine vision model 420 may receive the first output image, the second output image, and the third output image and generate first output data, second output data, and third output data respectively corresponding to the first output image, the second output image, and the third output image. The machine vision model 420 may determine result data by performing an ensemble on the first output data, the second output data, and the third output data, or a processor may determine the result data by performing the ensemble on the first output data, the second output data, and the third output data that are output by the machine vision model 420. The machine vision model 420 may have corresponding plural inputs and plural outputs, or the machine vision model 420 may be implemented multiple times (e.g., in parallel) such that the plural outputs are generated at the same time.

FIG. 5 illustrates example generated images in accordance with one or more embodiments. The description provided with reference to FIGS. 1 to 4B may also apply to FIG. 5.

Referring to FIG. 5, a generative model (e.g., the generative model 410 in FIG. 4B) may generate first images 510-1 to 510-3 based on a first raw image and may generate second images 520-1 to 520-3 based on a second raw image.

The first images 510-1 to 510-3 may be generated based on the same first raw image but may include different semantic information due to the corresponding different noise inputs. Similarly, the second images 520-1 to 520-3 may be also generated based on the same second raw image but may include different semantic information due to the corresponding different noise inputs.

When determined based on a machine vision model (e.g., the machine vision model 420 in FIG. 4B), output images (e.g., the first images 510-1 to 510-3) input to the machine vision model may be data augmented images. However, the first images 510-1 to 510-3 (or the second images 520-1 to 520-3) may be images generated based on a generative model and may differ from data generated by a data augmentation method based on signal processing through simple noise. More specifically, semantic augmentation including semantic information may be possible by utilizing a generative model according to various examples. For example, in various examples, the generative model may change semantic information on texture information, occlusion information, and/or viewpoint information of an output image.

FIG. 6 illustrates an example electronic device in accordance with one or more embodiments.

Referring to FIG. 6, an electronic device 600 may include a processor 601, a memory 603, and a sensor 605. The electronic device 600 may further include any or any combination of generative ISPs 607, 609, and 611 that may be respectively configured to perform any one or any combination of operations described above with reference to FIGS. 1 to 5. The sensor 605 may be an image sensor or representative of one or more image sensors, and may also be representee of one or more cameras that include the image sensors. Still further, the electronic device 600 may include an interface 613 of the electronic device 600, which may be representative of all user interface components of the electronic device 600 as well as other input and/or output devices of the electronic device 600. The electronic device 600 may be the electronic device described with reference to FIGS. 1 to 5. For example, the electronic device may include various types of products such as a personal computer, a laptop computer, a tablet computer, a smart phone, a television, a smart home appliance, an intelligent vehicle, a kiosk, a defect detection device, and a wearable device, as non-limiting examples.

The processor 601 may perform various processing operations of the electronic device 600 (e.g., depending on the functionalities of the electronic device 600, such as smart phone functions of the smart phone electronic device or defect detection indicating functions of the defect detection device. In addition, the processor 601 may be configured to perform any one or any combination of operations described above with reference to FIGS. 1 to 5. The processor 601, and/or any or any combination of the generative ISPs 607, 609, and 611, may be configured obtain a plurality of output images by inputting a raw image, e.g., captured by the sensor 605, into a generative model as described according to various examples. As a non-limiting example, the processor may be configured to obtain pieces of output data respectively corresponding to the plurality of output images by inputting the plurality of output images into a machine vision model, may determine result data by performing an ensemble on the pieces of output data, and control other operations of the electronic device 600 based on that determined result data. The processor 601 may include the generative ISP 611, the sensor 605 may include the generative ISP 607, and/or the electronic device 600 may have the generative ISP 609 as a separate component from the processor 601 and the sensor 605.

The memory 603 is representative of volatile memories and/or a non-volatile memories. The memory 603 may store any of the generative models and machine vision models described herein. In addition, the memory 603 may store instructions, which when executed by the processor 601, may configure the processor 601 to perform any or any combination of the operations described herein. The memory 603 may further include an object point cloud memory that stores a sample point that is a light detection and ranging (LiDAR) point cloud corresponding to an object.

The electronic device 600 may further include other components than the ones shown in the drawings. For example, the electronic device 600 may further include a communication module. In addition, for example, the electronic device 600 may further include other components such as a transceiver, various other types of sensors, and databases.

The electronic devices, the ISPs, the processors, memories, sensor, image sensors, and interfaces described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-6 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations).

Instructions or software to control computing hardware, for example, one or more processors or computers, to implement the hardware components and perform the methods as described above may be written as computer programs, code segments, instructions or any combination thereof, for individually or collectively, and/or independently or uniformly, instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. The instructions or software may be embodied permanently or temporarily in such one or more non-transitory computer-readable storage media. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method, the method comprising:
generating a plurality of output images using a generative model that is provided a raw image of an image sensor;
generating, using a machine vision model that is provided the plurality of output images, plural output data respectively corresponding to the plurality of output images; and
generating result data of the machine vision model by performing an ensemble on the plural output data.

2. The method of claim 1, wherein the generating of the plurality of output images comprises generating a plurality of noise images through random sampling, and generating the plurality of output images by the generative model respectively based on the generated plurality of noise images.

3. The method of claim 2, wherein the generating of the plurality of noise images comprises generating the plurality of noise images based on respective performances of at least one of Gaussian sampling or Poisson sampling.

4. The method of claim 1, wherein each of the plurality of output images is differently generated by inputting the raw image and a respective different noise image into the generative model.

5. The method of claim 1, wherein the ensembling of the plural output data comprises performing a combining of respective probabilistic data of the plural output data, or selecting of respective probabilistic data from among the plural output data, to generate the result data.

6. The method of claim 4, wherein the ensembling of the plural output data comprises performing the selecting, including generating the result data using a determined maximum confidence value for each corresponding element of the probabilistic data of the plural output data, where each of the plural output data include plural probabilistic data elements.

7. The method of claim 1, wherein the generative model comprises at least one of a diffusion model or a generative adversarial network (GAN) model.

8. The method of claim 1, wherein the plurality of output images are red, green, and blue (RGB) images respectively generated by the generative model corresponding to the raw image that is input to the generative model.

9. The method of claim 1, wherein the machine vision model comprises at least one of an object detection model, an image segmentation model, or defect detection model.

10. The method of claim 1, wherein the generative model is trained to optimize a performance of the machine vision model.

11. The method of claim 10, wherein the generative model and the machine vision model are trained together end-to-end.

12. The method of claim 1, further comprising training the generative model and the machine vision model together end-to-end.

13. The image processing method of claim 1, wherein the plurality of output images comprises different semantic information.

14. The method of claim 1, wherein the generating of the plurality of output images is performed using one or more pipelines of processing elements of a generative image signal processor (ISP).

15. An electronic device comprising:
an image sensor configured to generate a raw image; and
a processor configured to:
generate a plurality of output images using a generative model provided the raw image;
generate, using a machine vision model that is provided the plurality of output images, plural output data respectively corresponding to the plurality of output images; and
generate result data of the machine vision model through performance of an ensemble on the plural output data.

16. The electronic device of claim 15, wherein the processor is further configured to generate a plurality of noise images through random sampling, and generates each of the plurality of output images by the generative model based on a corresponding one of the generated plurality of noise images input to the generative model.

17. The electronic device of claim 15, wherein, for the ensembling, the processor is configured to perform a combining of respective probabilistic data of the plural output data, or a selecting of respective probabilistic data from among the plural output data, to generate the result data.

18. The electronic device of claim 17, wherein, for the ensembling, the processor is configured to perform the selecting, including a generation of the determined result data using a determined maximum confidence value for each corresponding element of the probabilistic data of the plural output data, where each of the plural output data include plural probabilistic data elements.

19. The electronic device of claim 15, wherein the plurality of output images are red, green, and blue (RGB) images respectively generated by the generative model corresponding to the raw image that is input to the generative model.

20. The electronic device of claim 15, wherein the processor comprises at least a generative image signal processor (ISP) that is configured to implement the generative model using one or more pipelines of processing elements of the generative ISP.

21. The electronic device of claim 15, wherein the generative model and the machine vision model are configured as having been trained together end-to-end.
